(19) United States
(12) Patent Application Publication
(10) Pub. No.: US 2011/0148706 A1
(43) Pub. Date: Jun. 23, 2011

(54) ANTENNA WITH CONTROLLED SIDELOBE CHARACTERISTICS

(75) Inventors: Soon-Young EOM, Daejeon (KR); Jong-Ho Kim, Daejeon (KR); Joung-Myoun Kim, Daejeon (KR); Young-Bae Jung, Daejeon (KR); Soon-Ik Jeon, Daejeon (KR); Chang-Joo Kim, Daejeon (KR)

(73) Assignee: ELECTRONICS AND TELECOMMUNICATIONS RESEARCH INSTITUTE, Daejeon (KR)

(21) Appl. No.: 12/847,221

(22) Filed: Jul. 30, 2010

(30) Foreign Application Priority Data
Dec. 18, 2009 (KR) 10-2009-0127326
Feb. 10, 2010 (KR) 10-2010-0012408

(51) Int. Cl. H01Q 3/00

(52) U.S. Cl. 342/372

(57) ABSTRACT

An antenna with controlled sidelobe characteristics includes: a power coupler configured to receive a signal to be transmitted and generate and output a main channel signal and an auxiliary channel signal; a main channel power distributor configured to receive the outputted main channel signal and distribute power of the main channel signal; a main antenna configured to receive the power-distributed signal, the main antenna including a one-dimensional or two-dimensional array of a number of antenna elements; a vector signal controller configured to control amplitude and phase of the auxiliary channel signal; an auxiliary channel power distributor configured to receive the controlled amplitude and phase of the auxiliary channel signal and distribute power of the auxiliary channel signal; and an auxiliary antenna independently installed separate from the main antenna, the auxiliary antenna including an antenna element or an array of a number of antennas.

### CROSS-REFERENCE(S) TO RELATED APPLICATIONS

The present application claims priority of Korean Patent Application No(s). 10-2009-0127326 and 10-2010-0012408, filed on Dec. 18, 2009, and Feb. 10, 2010, respectively, which are incorporated herein by reference in their entirety.

### BACKGROUND OF THE INVENTION

1. Field of the Invention

Exemplary embodiments of the present invention relate to an array antenna; and, more particularly, to an antenna configured to control sidelobe characteristics, which are radiation pattern characteristics of an array antenna.

2. Description of Related Art

In general, a wireless terrestrial/satellite communication system transmits/receives data or signals using a predetermined frequency.

An important element for transmitting and receiving signals in the wireless terrestrial/satellite communication system is the antenna at the end of the system. The antenna needs to be configured to transmit and receive radio waves efficiently, and extensive research and development regarding antennas are in progress.

There are innumerable types of antennas, but commonly used high-frequency antennas include dipole antennas, monopole antennas, patch antennas, horn antennas, parabolic antennas, helical antennas, and slot antennas. Such antennas are variously applied and used according to the communication distance and service area.

Frequency resources, which are important media of the wireless terrestrial/satellite communication system, are limited and thus are efficiently used according to the service area or communication distance.

However, frequency interference occurring in some frequency bands severely restricts the use of radio frequencies. Consequently, antenna radiation pattern characteristics are severely restricted.

For example, when a radio frequency allocated for a next-generation terrestrial mobile communication service is also used by an adjacent nation as a maritime mobile satellite communication frequency band, mutual interference of the same frequency signals needs serious consideration. Such mutual interference must be analyzed and solved in advance to guarantee that the next-generation mobile communication service is properly provided.

FIG. 1 illustrates the shape of an antenna array for a conventional terrestrial mobile communication service. Main beams 102, 104, and 106 of the antenna radiation pattern are directed from the installation towers towards the terrestrial service area. However, some sidelobe beams 101, 103, and 105 face an interfering satellite 100, as illustrated in FIG. 1. A large number of interfering signals from the mobile communication base stations, in the worst case, are coupled successively and seriously affect the other satellite communication service. This limits the number of installed next-generation mobile communication base station antennas.

Furthermore, the number of mobile communication base station/repeater antennas tends to increase gradually in the future. Considering this, the problem of interfering radiation power of antennas needs to be solved fundamentally.

### SUMMARY OF THE INVENTION

An embodiment of the present invention is directed to an array antenna structure capable of controlling sidelobe characteristics of the radiation pattern of a terrestrial mobile communication base station array antenna.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an antenna with controlled sidelobe characteristics includes: a power coupler configured to receive a signal to be transmitted and to generate and output a main channel signal and an auxiliary channel signal; a main channel power distributor configured to receive the outputted main channel signal and to distribute power of the main channel signal; a main antenna configured to receive the power-distributed signal, the main antenna including a one-dimensional or two-dimensional array of a number of antenna elements; a vector signal controller configured to control amplitude and phase of the auxiliary channel signal; an auxiliary channel power distributor configured to receive the controlled amplitude and phase of the auxiliary channel signal and to distribute power of the auxiliary channel signal; and an auxiliary antenna independently installed separate from the main antenna, the auxiliary antenna including an antenna element or an array of a number of antennas.

In accordance with another embodiment of the present invention, an antenna with controlled sidelobe characteristics includes: a power coupler configured to receive a signal to be transmitted and generate and output a main channel signal and an auxiliary channel signal; a main channel power distributor configured to receive the outputted main channel signal and to distribute the main channel signal; a main antenna configured to receive the power-distributed signal, the main antenna including a one-dimensional or two-dimensional array of a number of antenna elements; a vector signal controller configured to control amplitude and phase of the auxiliary channel signal; an auxiliary channel power distributor configured to receive the outputted auxiliary channel signal and to distribute the auxiliary channel signal; and an auxiliary antenna configured to use a part of the main antenna in a combined or shared manner, the auxiliary antenna including an antenna element or a number of array antennas inside the main antenna.

### BRIEF DESCRIPTION OF THE DRAWINGS

FIG. 1 illustrates the shape of an array antenna for a conventional terrestrial mobile communication service.

FIG. 2 illustrates the operating principle of an antenna structure configured to reduce a signal level in an interfering direction in accordance with an embodiment of the present invention.

FIGS. 3A and 3B illustrate the internal construction of interfering antennas in accordance with embodiments of the present invention, respectively.

FIGS. 4A to 4D illustrate the installation position and structure of independent auxiliary antennas in accordance with embodiments of the present invention, respectively.

FIGS. 5A and 5B illustrate the construction and installation position of auxiliary antennas inside main antennas in accordance with embodiments of the present inventions, respectively.

FIG. 6A illustrates a method of using a reflector in the interfering direction of an interfering antenna in accordance with an embodiment of the present invention.

FIG. 6B illustrates a method of using an absorber in the interfering direction in accordance with an embodiment of the present invention.

FIG. 7 shows a result of simulation using the antenna structure, illustrated in FIG. 4A, in accordance with an embodiment of the present invention to suppress the radiation level in the interfering direction.

FIG. 8 shows a result of simulation using the antenna structure, illustrated in FIG. 5B, in accordance with an embodiment of the present invention to suppress the radiation level in the interfering direction.

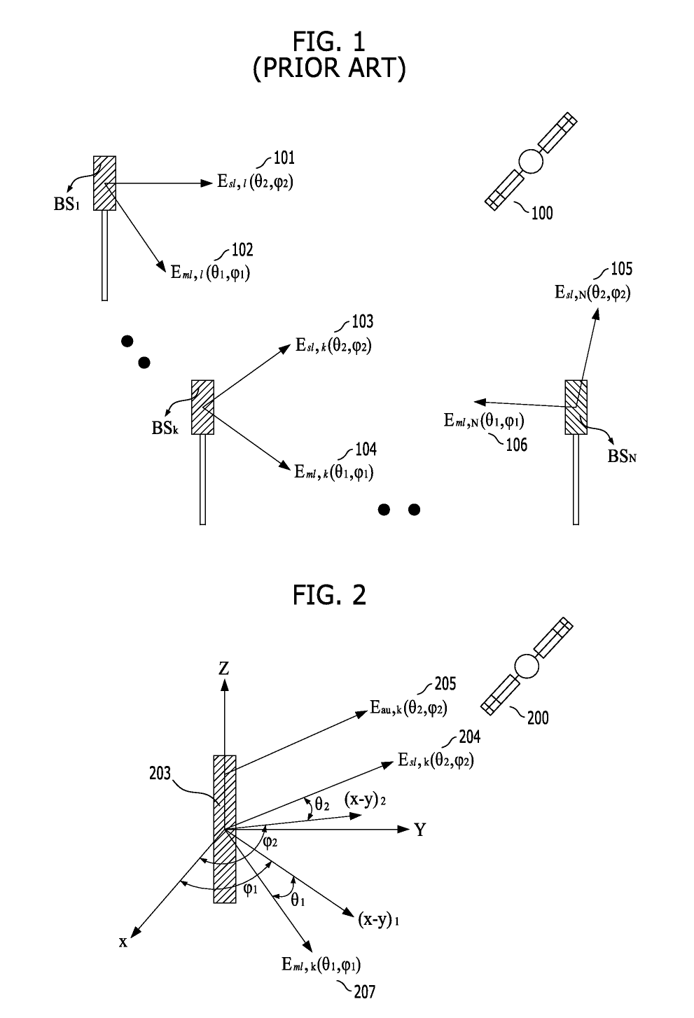

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

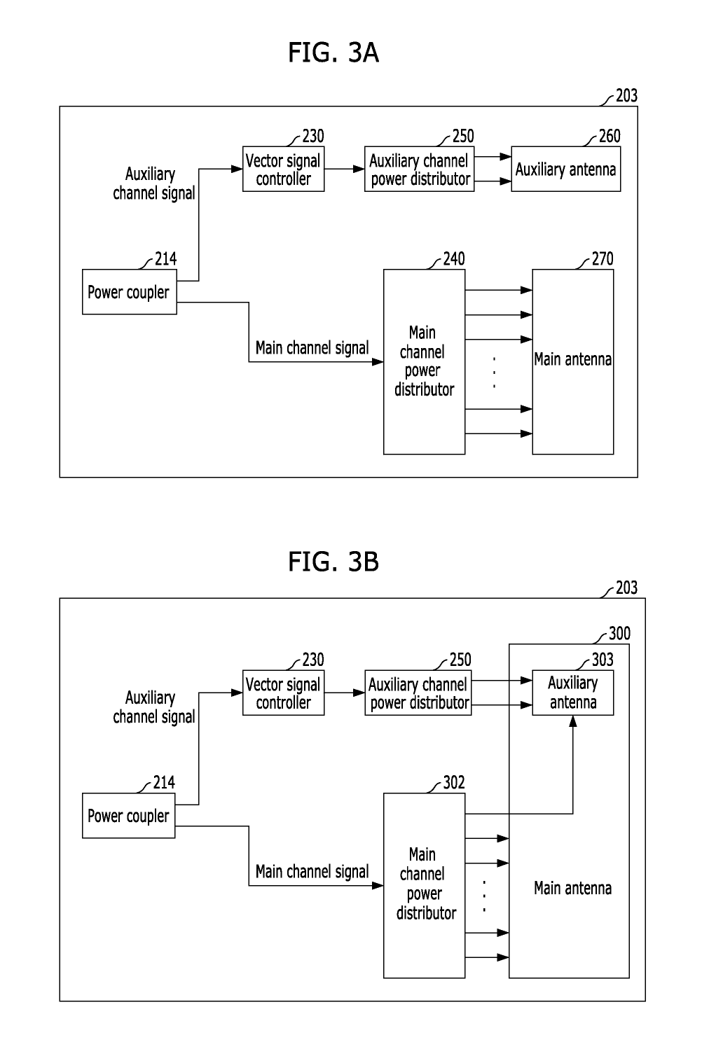

FIG. 2 illustrates the operating principle of an antenna structure configured to reduce a signal level in an interfering direction in accordance with an embodiment of the present invention.

Specifically, FIG. 2 illustrates a method for reducing the amount of interference by controlling two radiation signals, which are directed from an interfering antenna 203 towards an interfered satellite 200 or any other interfered wireless system (not shown).

Of the two signals, one signal 204 is radiated according to sidelobe characteristics of the interfering main antenna, and the other signal 205 is radiated from an auxiliary antenna, which is independent from or dependent on the main antenna, towards the interfered object.

In FIG. 2, E_{ml, k}(θ₁,φ₁) 207 refers to field strength in the main beam direction of the main antenna, E_{sl, k}(θ₂,φ₂) 204 refers to sidelobe field strength in the interfered object direction of the main antenna, and E_{au, k}(θ₂,φ₂) 205 refers to field strength of radiation pattern in the interfered object direction of the auxiliary antenna introduced artificially.

In FIG. 2, k refers to the k^{th} mobile communication base station antenna, θ₁ and θ₂ refer to elevations, and φ₁ and φ₂ refer to azimuths, respectively. The elevation and azimuth in the interfered object direction of the auxiliary antenna introduced artificially must be controlled so as to coincide with the sidelobe direction of the interfered object direction of the main antenna.

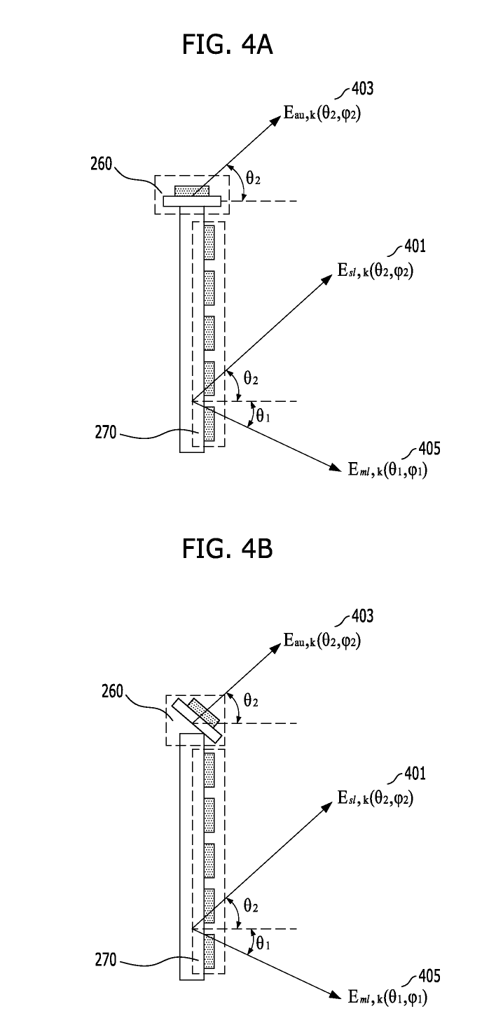

FIGS. 3A and 3B illustrate the internal construction of interfering antennas in accordance with embodiments of the present invention, respectively.

Specifically, FIG. 3A illustrates the internal construction of an interfering antenna 203 having an independent auxiliary antenna, and FIG. 3B illustrates the internal construction of an interfering antenna 203 having a dependent auxiliary antenna.

Considering that the present invention is directed to an antenna which exerts interference, the signal flow will be described in terms of a transmitting antenna.

The internal construction of the interfering antenna 203 having an independent auxiliary antenna illustrated in FIG. 3A will be described. When a signal to be transmitted is inputted to the interfering antenna 203, a power distributor or power coupler 214 forms two signal channels, i.e. a main signal channel and an auxiliary signal channel.

The power coupling or distribution ratio of the main channel and auxiliary channel signals is generally set to be 20 dB to 30 dB so as not to influence the main antenna radiation power.

The main channel signal outputted by the power coupler 214 is power-distributed by a main channel power distributor 240 and inputted to a main antenna 270. In general, the main antenna 270 includes a one- or two-dimensional array of a number of unit antenna elements. The main channel power distributor 240 may be a passive circuit or an active circuit including a power amplifier. If necessary, the main channel power distributor 240 may include a passive or active phase array circuit.

The auxiliary channel signal outputted by the power coupler 214 is directed to a vector signal controller 230, power-distributed by an auxiliary channel power distributor 250, and inputted to an auxiliary antenna 260. The auxiliary antenna 260 is independently installed separate from the main antenna 270, and may include a single antenna element or a number of array antennas.

The vector signal controller 230 is configured to control the amplitude and phase of the auxiliary channel signal. The auxiliary channel power distributor 250 may be a passive circuit or an active circuit including a power amplifier. If necessary, the auxiliary channel power distributor 240 may include a passive or active phase array circuit.

The internal structure illustrated in FIG. 3B, as well as the internal blocks, are the same as FIG. 3A, except for the position of installation of the auxiliary antenna 303, and repeated description thereof will be omitted herein.

However, it is to be noted that the auxiliary antenna 303 is a part of the main antenna 300, which is used in a combined or shared manner, and exists inside the main antenna 300. Therefore, partial input of the main channel power distributor 302 and output of the auxiliary channel power distributor 250 are combined and inputted together into the auxiliary antenna 303, as illustrated in FIG. 3B.

When installing the auxiliary antenna 303, the interfering direction needs to be considered. For example, the auxiliary antenna 303 may be directed in the interfering direction. The position of installation of the auxiliary antenna 303 is not limited. For example, the auxiliary antenna 303 may be in the same line of array as the main antenna 300. Alternatively, the auxiliary antenna 303 may be installed on the antenna top in the perpendicular direction.

Those skilled in the art can understand that the present invention is not limited to the above description of exemplary embodiments made with reference to the accompanying drawings.

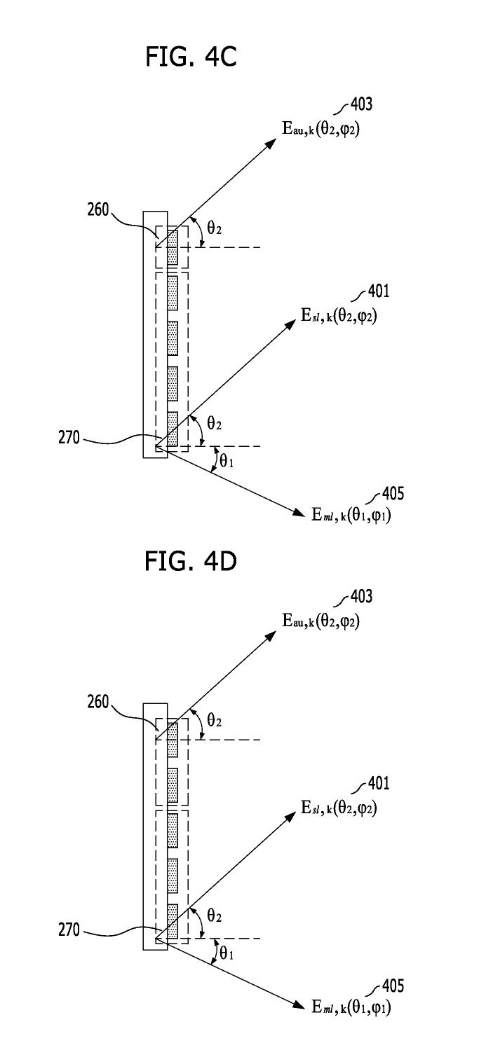

FIGS. 4A to 4D illustrate the installation position and structure of independent auxiliary antennas in accordance with embodiments of the present invention, respectively.

Specifically, FIG. 4A illustrates an auxiliary antenna 260 which is independent from a main antenna 270 and installed on the top horizontally. The maximum value of radiation pattern of the auxiliary antenna 260 in FIG. 4A is directed in the vertical direction.

FIG. 4B illustrates an auxiliary antenna 260 which is independent from a main antenna 270 and installed on the top at an angle of θ₂. The maximum value of radiation pattern of the auxiliary antenna 260 in FIG. 4B coincides with the interfered object direction.

The sidelobe level E_{sl, k}(θ₂,φ₂) 401 of the main antenna 270 in the interfered object direction and the beam lobe level E_{au, k}(θ₂,φ₂) 403 of the auxiliary antenna 150 are spatially power-coupled and form interfering power defined by Equation 1 below.

$${P}_{I} \approx {\vert {E}_{i , k} ( {θ}_{2} , {φ}_{2} ) \vert}^{2} = {\vert {E}_{sl , k} ( {θ}_{2} , {φ}_{2} ) + {E}_{au , k} ( {θ}_{2} , {φ}_{2} ) \vert}^{2} \approx {\vert {E}_{sl , k} ( {θ}_{2} , {φ}_{2} ) \vert}^{2} + {\vert {E}_{au , k} ( {θ}_{2} , {φ}_{2} ) \vert}^{2} + 2 \vert {E}_{sl , k} ( {θ}_{2} , {φ}_{2} ) \vert \vert {E}_{au , k} ( {θ}_{2} , {φ}_{2} ) \vert cos Δψ \qquad Eq . 1$$

In Equation 1 above, in order satisfy a condition making zero interfering power, i.e. |E_{l,k}(θ₂,φ₂)|²=0, the following conditions must be satisfied: Δψ=180° and |E_{sl, k}(θ₂,φ₂)|=|E_{au, k}(θ₂,φ₂)|. These conditions are precisely performed by the vector signal controller 230 of the auxiliary antenna 260. The same condition is applied for each operating frequency, and the amplitude and phase of a controlled auxiliary channel signal may have different conditions.

Every action employed to cause signal attenuation or suppression effect in the interfering direction by the auxiliary antenna 260 must not seriously degrade characteristics of the main antenna 270. To this end, a power amplifier may be included in the power distributor 250 inside the auxiliary channel, and the auxiliary antenna 260 may have an array antenna structure or an active phased array structure.

FIG. 4C illustrates an auxiliary antenna 260 which is independent from a main antenna 270 and installed as a unit antenna element on the same plane as the main antenna 270.

The maximum value of radiation pattern of the auxiliary antenna 260 in FIG. 4C is directed in the vertical direction.

FIG. 4D illustrates an auxiliary antenna 260 which is independent from a main antenna 270 and installed as at least two array elements on the same plane as the main antenna 270. The beam steering is controlled so that the maximum value of radiation pattern of the auxiliary antenna 260 in FIG. 4D coincides with the interfered object direction.

The sidelobe level E_{sl, k}(θ₂,φ₉₂) 401 of the main antenna 270 in the interfered object direction and the beam lobe level E_{au, k}(θ₂, φ₂) 403 of the auxiliary antenna 260 are spatially power-coupled and removed according to the same operating principle and conditions as in the case of FIGS. 3A and 3B.

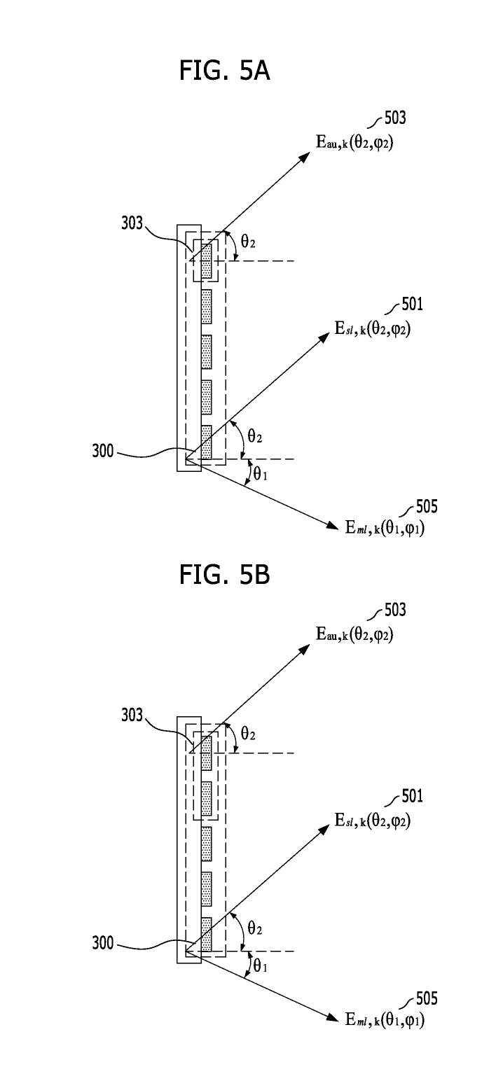

FIGS. 5A and 5B illustrate the construction and installation position of auxiliary antennas inside main antennas in accordance with embodiments of the present inventions, respectively.

Specifically, FIG. 5A illustrates an auxiliary antenna 303 installed dependently inside a main antenna 300, and a unit antenna element may be used in a combined or shared manner as the auxiliary antenna 303 and the main antenna 300.

The maximum value of radiation pattern of the auxiliary antenna 303 in FIG. 5A is directed in the vertical direction. Signals outputted from the main channel power distributor 302 and the auxiliary channel power distributor 250 are simultaneously power-coupled and inputted to the auxiliary antenna 303.

FIG. 5B illustrates an auxiliary antenna 303 installed dependently inside a main antenna 300, and at least two array antenna elements may be used in a combined or shared manner as the auxiliary antenna 303 and the main antenna 300.

The beam steering is controlled so that the maximum value of radiation pattern of the auxiliary antenna 303 coincides with the interfered object direction. Signals outputted from the main channel power distributor 302 and the auxiliary channel power distributor 250 are simultaneously power-coupled and inputted to the auxiliary antenna 303.

The sidelobe level E_{sl, k}(θ₂,φ₂) 501 of the main antenna 300 in the interfered object direction and the beam lobe level E_{au, k}(θ₂,φ₂) 503 of the auxiliary antenna 303 are spatially power-coupled and removed according to the same operating principle and conditions as in the case of FIGS. 3A and 3B.

In accordance with the present invention, antennas are installed at places having relative elevation and azimuth coordinates of positions different from those of the interfered object, and respective antennas thus have independent interference control information.

The present invention provides, as another method for reducing radiation power of the interfering antenna towards the interfered object, use of a reflector and an absorber in the interfering direction.

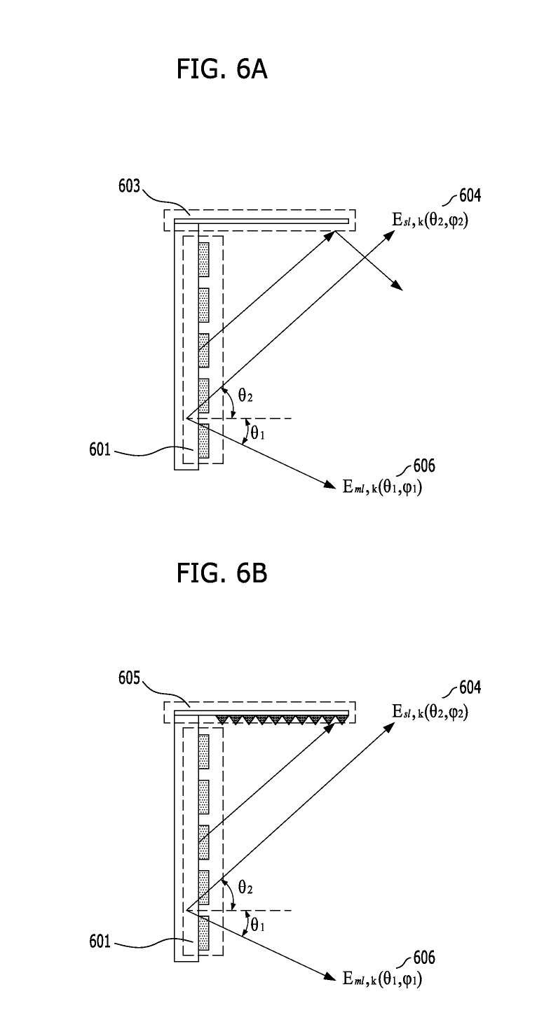

FIG. 6A illustrates a method of using a reflector in the interfering direction of an interfering antenna in accordance with an embodiment of the present invention.

The role of the reflector 601 in FIG. 6A is to direct the interfering radiation power 604 of the interfering antenna 601 to a different direction to reduce the amount of interference. The size of the reflector may be varied according to interference amount characteristics.

FIG. 6B illustrates a method of using an absorber in the interfering direction in accordance with an embodiment of the present invention.

The absorber 605 in FIG. 6B is configured to directly absorb interfering radiation power of the interfering antenna 601 to reduce the amount of interference. The size of the absorber 605 may be varied according to interference amount characteristics.

The methods of using a reflector 603 and an absorber 605 in the interfering direction of the interfering antenna 601 have a lower degree of suppression than a method of using an auxiliary antenna 150 to remove interfering signals, but can be realized more easily.

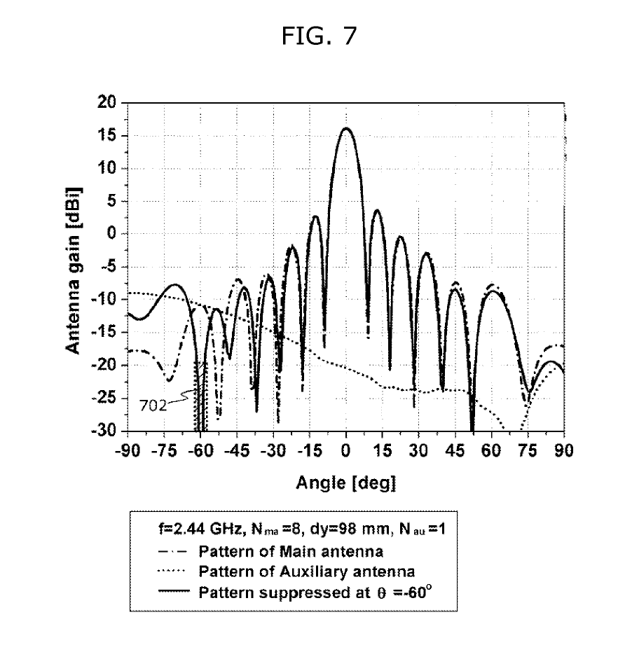

FIG. 7 shows a result of simulation using the antenna structure, illustrated in FIG. 4A, in accordance with an embodiment of the present invention to suppress the radiation level in the interfering direction.

The simulation condition is given in Table 1 below.

TABLE 1

| | |
|---|---|
| Design operating frequency (f) | 2.44 GHz |
| Main antenna array element number | Eight |
| (Nₘₐ) | |
| Main antenna element array | 98 mm (0.797λ₀) |
| interval (d_{y}) | |
| Auxiliary antenna element number | One (Installed on top |
| (Nₐᵤ) | separate from main |
| | antenna) |
| Sidelobe pattern suppression | −60° (Interfering object |
| position | direction) |

It is clear from the simulation result shown in FIG. 7 that, within a range 702 of −60±1°, radiation level characteristics of about 40 dBc are obtained using the antenna structure illustrated in FIG. 4A in accordance with the present invention. This means that the relative radiation level suppression effect is at least about 12.9 dB.

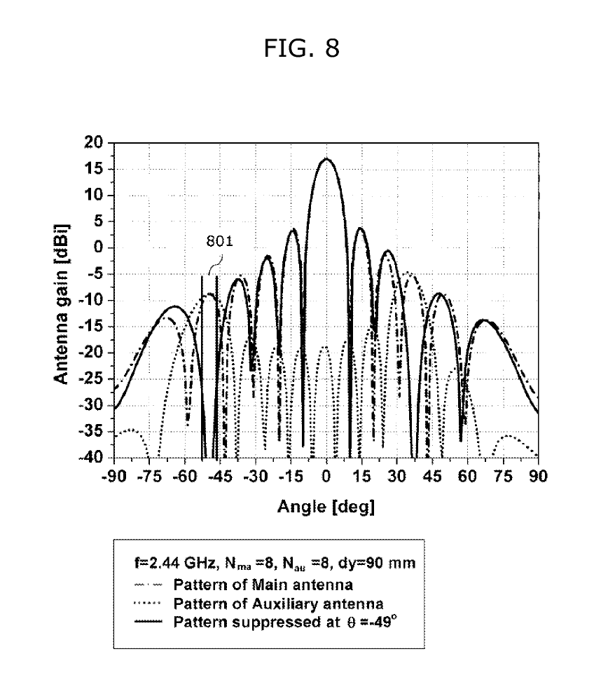

FIG. 8 shows a result of simulation using the antenna structure, illustrated in FIG. 5B, in accordance with an embodiment of the present invention to suppress the radiation level in the interfering direction.

The simulation condition is given in Table 2 below.

TABLE 2

| | |
|---|---|
| Design operating frequency (f) | 2.44 GHz |
| Main antenna array element number | 8 |
| (Nₘₐ) | |
| Main antenna element array | 90 mm (0.73λ₀) |
| interval (d_{y}) | |
| Auxiliary antenna element number | 8 (also used as main |
| (Nₐᵤ) | antenna) |
| Sidelobe pattern suppression | −49° (Interfering object |
| position | direction) |

It is clear from the simulation result shown in FIG. 8 that, within a range 801 of −49±1°, radiation level characteristics of about 55 dBc are obtained using the antenna structure illustrated in FIG. 5B in accordance with the present invention. This means that the relative radiation level suppression effect is at least about 29.1 dB.

The antenna structure in accordance with the exemplary embodiments of the present invention guarantees that, in a complicated wireless communication environment, a wireless communication service is provided smoothly with reduced interfering signals and interfered signals in any direction.

Furthermore, the antenna structure is expected to be widely applied to a future next-generation mobile communication base station/repeater antenna system with considerable economic merits.

While the present invention has been described with respect to the specific embodiments, it will be apparent to those skilled in the art that various changes and modifications may be made without departing from the spirit and scope of the invention as defined in the following claims.

What is claimed is:

1. An antenna with controlled sidelobe characteristics, comprising:
a power coupler configured to receive a signal to be transmitted and generate and output a main channel signal and an auxiliary channel signal;
a main channel power distributor configured to receive the outputted main channel signal and distribute power of the main channel signal;
a main antenna configured to receive the power-distributed signal, the main antenna comprising a one-dimensional or two-dimensional array of a number of antenna elements;
a vector signal controller configured to control amplitude and phase of the auxiliary channel signal;
an auxiliary channel power distributor configured to receive the controlled amplitude and phase of the auxiliary channel signal and distribute power of the auxiliary channel signal; and
an auxiliary antenna independently installed separate from the main antenna, the auxiliary antenna comprising an antenna element or an array of a number of antennas.

2. The antenna of claim 1, wherein the auxiliary antenna is installed in a predetermined position on a periphery of the main antenna to spatially power-couple a sidelobe level of the main antenna with a beam lobe level of the auxiliary antenna and control radiation pattern characteristics of the main antenna.

3. The antenna of claim 2, wherein the auxiliary antenna is installed independent from the main antenna and installed horizontally on a top of the main antenna, and a maximum value of radiation pattern of the auxiliary antenna is directed to a vertical direction.

4. The antenna of claim 2, wherein the auxiliary antenna is installed independent from the main antenna and installed at a predetermined angle on a top of the main antenna, and a maximum value of radiation pattern of the auxiliary antenna coincides with an interfered object direction.

5. The antenna of claim 2, wherein the auxiliary antenna is installed independent from the main antenna and installed as a unit antenna element on the same plane as the main antenna, and a maximum value of radiation pattern of the auxiliary antenna is directed to a vertical direction.

6. The antenna of claim 1, wherein the auxiliary antenna is installed independent from the main antenna and installed as at least two array elements on the same plane as the main antenna, and beam steering is controlled so that a maximum value of radiation pattern of the auxiliary antenna coincides with an interfered object direction.

7. An antenna with controlled sidelobe characteristics, comprising:
a power coupler configured to receive a signal to be transmitted and generate and output a main channel signal and an auxiliary channel signal;
a main channel power distributor configured to receive the outputted main channel signal and power-distribute the main channel signal;
a main antenna configured to receive the power-distributed signal, the main antenna comprising a one-dimensional or two-dimensional array of a number of antenna elements;
a vector signal controller configured to control amplitude and phase of the auxiliary channel signal;
an auxiliary channel power distributor configured to receive the outputted auxiliary channel signal and power-distribute the auxiliary channel signal; and
an auxiliary antenna configured to use a part of the main antenna in a combined or shared manner, the auxiliary antenna comprising an antenna element or a number of array antennas inside the main antenna.

8. The antenna of claim 7, wherein the auxiliary antenna is configured to receive signals outputted from the main channel power distributor and the auxiliary channel power distributor and power-coupled simultaneously.

9. The antenna of claim 7, wherein the auxiliary antenna is dependently installed inside the main antenna, the antenna element is used as the main antenna in a combined or shared manner, and a maximum value of radiation pattern of the auxiliary antenna is directed to a vertical direction.

10. The antenna of claim 7, wherein the auxiliary antenna is dependently installed inside the main antenna, at least two array antenna elements are used as the main antenna in a combined or shared manner, and beam steering is controlled so that a maximum value of radiation pattern of the auxiliary antenna coincides with an interfered object direction.

11. An antenna with controlled sidelobe characteristics, comprising:
a reflector configured to direct interfering radiation power from an interfered object direction to a different direction to reduce radiation power of the antenna.

12. An antenna with controlled sidelobe characteristics, comprising:
an absorber configured to directly absorb interfering radiation power directed to an interfered object and reduce an amount of interference to reduce radiation power of the antenna.
